(19) United States
(12) Patent Application Publication
(10) Pub. No.: US 2026/0367019 A1
(43) Pub. Date: Nov. 19, 2026

(54) STRUCTURE FOR BATTERY ANALYSIS, X-RAY DIFFRACTOMETER, AND METHOD FOR MANUFACTURING STRUCTURE FOR BATTERY ANALYSIS

(71) Applicant: RIGAKU CORPORATION, Tokyo (JP)

(72) Inventors: Yuji SHIRAMATA, Tokyo (JP); Hikari TAKAHARA, Tokyo (JP); Kazuki YOSHII, Osaka (JP); Tadao TAGAWA, Osaka (JP)

(73) Assignee: RIGAKU CORPORATION, Tokyo (JP)

(21) Appl. No.: 19/645,350

(22) Filed: Apr. 13, 2026

(30) Foreign Application Priority Data
May 19, 2025 (JP) 2025-083285

(51) Int. Cl. G01N 23/20008; H01M 10/42; H01M 50/109

(52) U.S. Cl. CPC G01N 23/20008; H01M 10/4285; H01M 50/109; G01N 2223/317; G01N 2223/611

(57) ABSTRACT

According to an aspect of the present disclosure, a structure for battery analysis is provided in which the structure includes a first conductive member, a second conductive member configured to be joined to the first conductive member, and an insulating member configured to insulate the first conductive member and the second conductive member from each other, the first conductive member and the second conductive member are joined to each other via the insulating member to form a hollow battery housing unit, the battery housing unit is configured to house a test specimen for a coin cell therein and to conduct an electrical signal output from the test specimen to the outside, and on at least one of end surfaces of the battery housing unit, an X-ray window that allows X-rays to pass therethrough is provided.

### CROSS-REFERENCE TO RELATED APPLICATION

The present application claims priority under 35 U.S.C. § 119 to Japanese Patent Application No. 2025-083285, filed May 19, 2025, the contents of which are incorporated herein by reference in their entirety.

### BACKGROUND

The present disclosure relates to a structure for battery analysis, an X-ray diffractometer, and a method for manufacturing a structure for battery analysis.

### RELATED ART

WO2021/038943 discloses prior art relating to a structure for battery analysis. The prior art according to WO2021/038943 includes a pressurization unit provided with a pressurization mechanism and a pressure-receiving unit that receives pressure acting on a sample battery, and pressurizes the sample battery housed in a hollow portion of the battery housing unit between the pressurization unit and the pressure-receiving unit to suppress expansion and contraction thereof.

### SUMMARY

However, when analyzing a sample battery (test specimen) by X-ray diffraction using prior art such as that disclosed in WO2021/038943, the manufacturing process differs from that of coin cells available on the market, and therefore there exists a need to perform analysis under conditions closer to the manufacturing process of the actual product.

In view of the above circumstances, the present disclosure provides a structure that enables the manufacture of a highly hermetic and highly precise structure using processing methods similar to those used for commercially available coin cells, thereby allowing an X-ray diffraction measurement to be performed on a test specimen (sample battery) under conditions close to those when manufactured as a commercially available coin cell.

According to an aspect of the present disclosure, there is provided a structure for battery analysis, including: a first conductive member; a second conductive member configured to be joined to the first conductive member; and an insulating member configured to insulate the first conductive member and the second conductive member from each other, the first conductive member and the second conductive member being joined to each other via the insulating member to form a hollow battery housing unit, the battery housing unit being configured to house a test specimen for a coin cell therein and to conduct an electrical signal output from the test specimen to the outside, on at least one of end surfaces of the battery housing unit, an X-ray window that allows X-rays to pass therethrough being provided.

According to such an aspect, it is possible to manufacture a highly hermetic and highly precise structure using processing methods similar to those used for commercially available coin cells, thereby allowing an X-ray diffraction measurement to be performed on a test specimen under conditions close to those when manufactured as a commercially available coin cell.

### BRIEF DESCRIPTION OF DRAWINGS

FIGS. 1A and 1B are perspective views showing the external appearance of a structure 1 according to one embodiment, as viewed from a cap 21 side (FIG. 1A) and from a casing 22 side (FIG. 1B).

FIG. 2 is an exploded view showing components of the structure 1.

FIG. 3 is a flowchart showing an example of a method for manufacturing the structure 1 according to one embodiment.

FIG. 4 is a side view showing an example of an X-ray diffractometer 5.

FIGS. 5A and 5B are graphs showing charge-discharge characteristics of the structure according to the example (FIG. 5A) and a commercially available coin cell according to a comparative example (FIG. 5B).

FIG. 6 is a graph showing the results of X-ray diffraction measurements performed on both the structure according to the example and the structure according to the comparative example.

### DETAILED DESCRIPTION

Hereinafter, an embodiment of the present disclosure will be described with reference to the drawings. Various features described in the embodiment below can be combined with each other. Each component, material, dimension, tolerance, process condition, measurement condition, numerical range, processing procedure, and the like disclosed in one embodiment is merely illustrative, and may be replaced with publicly known or well-known means that are functionally equivalent thereto.

### Embodiment

In overview, a structure according to one embodiment is for battery analysis. The structure includes a first conductive member, a second conductive member that can be joined to the first conductive member, and an insulating member that insulates the first conductive member and the second conductive member from each other. The first conductive member and the second conductive member are joined to each other via the insulating member to form a hollow battery housing unit. The battery housing unit is configured to house a test specimen for a coin cell therein and to conduct an electrical signal output from the test specimen to the outside. An X-ray window that allows X-rays to pass therethrough is provided on at least one of the end surfaces of the battery housing unit. According to such an aspect, it is possible to manufacture a highly hermetic and highly precise structure using processing methods similar to those used for commercially available coin cells, thereby allowing an X-ray diffraction measurement to be performed on a test specimen under conditions close to those when manufactured as a commercially available coin cell.

### 1. Structure 1

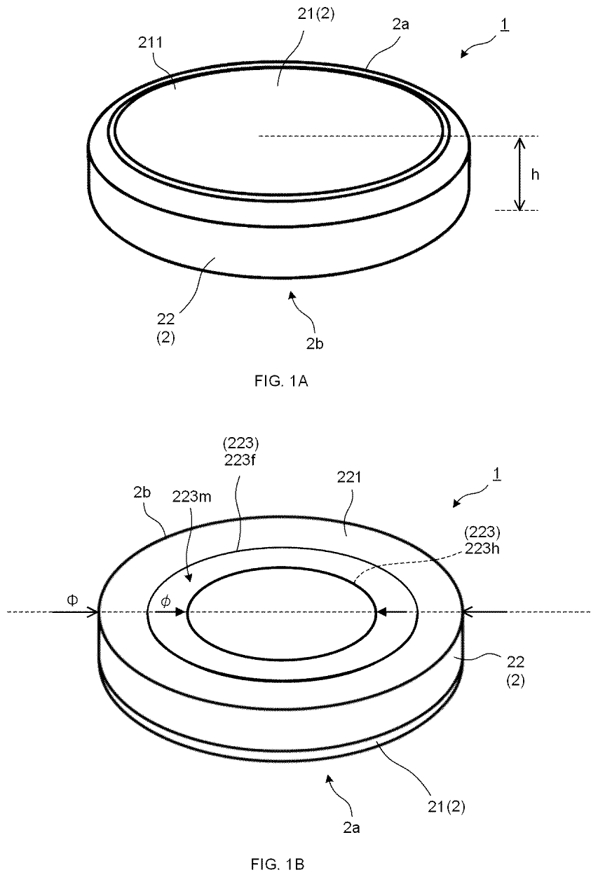

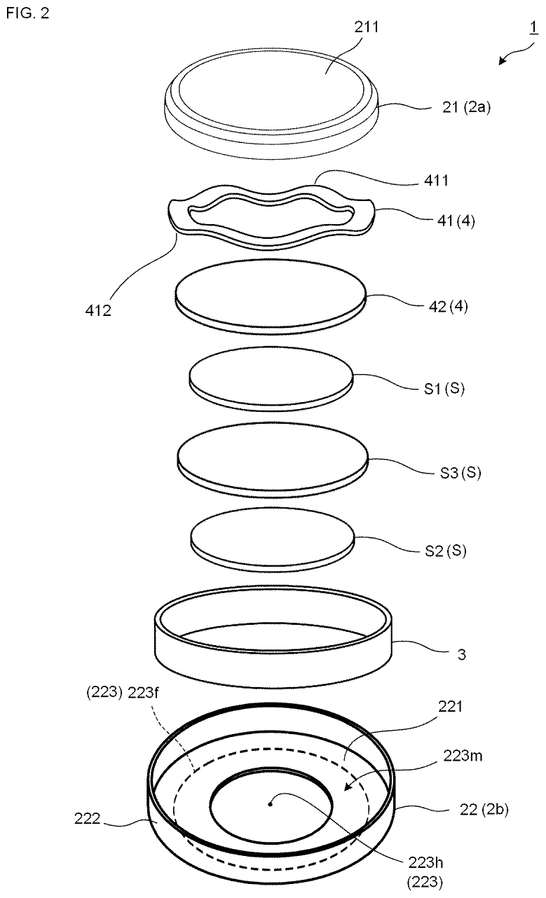

Hereinafter, a structure 1 for battery analysis according to one embodiment, which may be encompassed in the aforementioned summary, will be described with reference to FIGS. 1A, 1B, and 2.

FIGS. 1A and 1B are perspective views showing the external appearance of the structure 1 according to one embodiment, as viewed from the cap 21 side (FIG. 1A) and from the casing 22 side (FIG. 1B). FIG. 2 is an exploded view showing components of the structure 1. As shown in FIGS. 1A, 1B, and 2, the structure 1 includes at least a battery housing unit 2, a gasket 3 that is an example of an insulating member, and a pressurization mechanism 4, and the battery housing unit 2 is configured to house a test specimen S for a coin cell therein. The test specimen S is, for example, a lithium-ion battery. However, the example is not limited thereto, and the test specimen S may be a sodium-ion battery, a potassium-ion battery, a magnesium-ion battery, an aluminum-ion battery, a zinc-ion battery, a calcium-ion battery, a lithium-sulfur battery, or the like.

The structure 1 may be provided as a finished product as shown in FIGS. 1A and 1B, or as a kit including at least the battery housing unit 2, the gasket 3, and the pressurization mechanism 4 as constituent components as shown in FIG. 2 may be implemented. In the former case, the structure 1 may be implemented in a state where the test specimen S is housed in the battery housing unit 2. In the latter case, a person who has obtained the kit may subsequently house the test specimen S in the battery housing unit 2. In a case where the kit is to be completed after housing the test specimen S, a crimping step using a crimping machine may be performed. The crimping step is a step also used in the manufacture of commercially available coin cells. In one embodiment, the term “structure 1” may be used regardless of whether it is a finished product, a kit, or whether or not the test specimen S is housed therein.

### (Battery Housing Unit 2)

As shown in FIGS. 1A and 1B, the battery housing unit 2 constitutes a housing of the structure 1. Preferably, the shape of the battery housing unit 2 is substantially the same as the shape of a commercially available coin cell, and the size thereof is also preferably substantially the same. For example, the battery housing unit 2 has a substantially cylindrical shape with a diameter of 30 mm or less and a height of 6 mm or less. When the diameter is represented by Φ (mm), it is preferably 30≥Φ≥3, more preferably 25≥Φ≥5, and even more preferably 20≥Φ≥10. Specifically, for example, Φ=30, 29, 28, 27, 26, 25, 24, 23, 22, 21, 20, 19, 18, 17, 16, 15, 14, 13, 12, 11, 10, 9, 8, 7, 6, 5, 4, or 3, or the diameter may be within a range between any two of the numerical values exemplified herein. When the height is denoted as h (mm), it is preferably 6≥h≥3, more preferably 6≥h≥4, and even more preferably 6≥h≥5. Specifically, for example, h=6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, or 3, or the height may be within a range between any two of the numerical values exemplified herein. According to such an aspect, the structure 1 can be provided in a size that encompasses the largest standard coin cell.

The battery housing unit 2 comprises a cap 21 and a casing 22, each of which is electrically conductive. The cap 21 is formed in a substantially disk shape, with its outer peripheral edge bent downward in a stepped shape. Meanwhile, the casing 22 is formed in a substantially cylindrical cup shape including an end surface 221 (geometrically a bottom surface) and a side surface 222, and an opening end of the casing 22 has an outer diameter that allows the opening end to fit over the bent edge of the cap 21. The material of the battery housing unit 2 may be, for example, SUS316L, or may be Al, Ni, Cu, Mo, or the like. The battery housing unit 2 may be mainly made of these selected materials, and the surfaces thereof may be Ni-plated.

The cap 21 and the casing 22 are plastically deformed by a crimping machine and joined to each other via a gasket 3 described later. As a result, a substantially cylindrical space is formed in which the end surface 211 on the cap 21 side and the end surface 221 on the casing 22 side face each other, and the test specimen S is hermetically housed in this space. Furthermore, the cap 21 and the casing 22 are electrically insulated from each other via the gasket 3.

An X-ray window 223 that allows X-rays to pass therethrough is preferably provided on at least one of the end surfaces 211 and 221 of the battery housing unit 2. In one embodiment, the X-ray window 223 is provided only on one of the end surfaces 211 and 221 (here, only on the end surface 221). According to such an aspect, simplification of the structure and clarification of the X-ray measurement position can be achieved, and alignment with an X-ray diffractometer 5 described later can also be facilitated. More specifically, the X-ray window 223 is formed in substantially the center of the end surface 221 of the casing 22. The shape of the X-ray window 223 is not particularly limited; however, the X-ray window 223 preferably has a substantially circular shape. In addition, the battery housing unit 2 has a substantially cylindrical shape as a whole, and therefore, the end surfaces 211 and 221 each also have a substantially circular shape. In this case, the ratio of the diameter φ of the X-ray window 223 to the diameter Φ of each of the end surfaces 211 and 221 is preferably 25% to 75%. This ratio is more preferably 30% to 70%, even more preferably 40% to 60%, and specifically, for example, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, or 75%. The ratio may be within a range between any two of the numerical values exemplified herein.

According to such an aspect, optically uniform X-ray irradiation with high symmetry becomes possible, and the reliability of measurement can be improved. Furthermore, by appropriately setting the size of the X-ray window 223, a balance between X-ray diffraction intensity and hermeticity can be ensured. Of course, instead of the substantially circular shape, the X-ray window 223 may have a substantially rectangular shape (particularly a substantially square shape), a substantially elliptical shape, or a substantially regular polygonal shape.

More specifically, the X-ray window 223 includes a through hole 223h formed in at least one of the end surfaces 211 and 221 of the battery housing unit 2 (in one example, the end surface 221), and an X-ray transmissive film 223f configured to cover the through hole 223h. In one embodiment, the X-ray transmissive film 223f is affixed to the outer side of the casing 22, but may alternatively be affixed to the inner side thereof. The shape of the X-ray transmissive film 223f is substantially circular, but is not limited thereto. The material of the X-ray transmissive film 223f is not particularly limited; for example, the X-ray transmissive film 223f includes a polymer material. The polymer material may be, for example, polyetherimide (PEI), polyimide (PI), or the like, and is preferably chemically stable against an electrolyte (not shown) contained in the test specimen S. According to such an aspect, it is possible to achieve both X-ray transmissivity and hermeticity while realizing the X-ray window 223 with a mechanically strong structure. Furthermore, by using a film material having both X-ray transmissivity and electrolyte resistance, highly reliable X-ray measurements can be performed for a long period of time.

The X-ray transmissive film 223f is preferably affixed to the outer peripheral edge of the through hole 223h via an adhesive (not shown) made of a suitable material. The adhesive is preferably applied to a margin 223m that is a part of the X-ray transmissive film 223f. More specifically, the X-ray transmissive film 223f is preferably arranged by being bonded to at least one of the cap 21 or the casing 22 (for example, the casing 22) with an adhesive (not shown) that is not dissolved by the electrolyte contained in the test specimen S. According to such an aspect, the fixation of the X-ray transmissive film 223f by the adhesive becomes less susceptible to the influence of the electrolyte, and the hermeticity and durability of the structure 1 can be improved. The adhesive may be, for example, an epoxy resin adhesive, and may be appropriately selected and used from a silicone adhesive, an acrylic adhesive, an instant adhesive, a rubber-based solvent adhesive, and the like depending on the properties of the electrolyte.

### (Gasket 3)

The gasket 3 is an annular member made of, for example, polypropylene (PP). The gasket 3 is configured to electrically insulate the cap 21 and the casing 22 when the cap 21 and the casing 22 are joined, and to prevent leakage of an electrolyte contained in the test specimen S. The gasket 3 is attached to the opening edge of the casing 22, and a peripheral portion thereof is plastically deformed and fixed by a crimping step. That is, the structure 1 includes the cap 21 (an example of a first conductive member 2a), the casing 22 (an example of a second conductive member 2b) that can be joined to the cap 21, and the gasket 3 (an example of an insulating member) that insulates the cap 21 and the casing 22 from each other. The cap 21 and the casing 22 are joined to each other via the gasket 3 (an example of an insulating member) to form a hollow battery housing unit 2.

### (Pressurization Mechanism 4)

The pressurization mechanism 4 is a member provided to apply surface pressure to the test specimen S to ensure electrical contact, and may be arranged inside the battery housing unit 2. In other words, the structure 1 further includes the pressurization mechanism 4 arranged inside the battery housing unit 2 and configured to apply pressure to the housed test specimen S.

In one embodiment, the pressurization mechanism 4 includes a wave washer 41 (an example of an elastic member) and a spacer 42 (an example of a plate-shaped member) bonded to the wave washer 41. The wave washer 41 is configured in a wave shape so as to have a plurality of convex portions 411 and concave portions 412, and has elasticity in a direction in which the components of the structure 1 are arranged. In addition, the wave washer 41 is formed in an annular shape and has electrical conductivity. The spacer 42 is a member configured in a plate shape and has electrical conductivity similar to the wave washer 41. That is, the pressurization mechanism 4 is electrically conductive. Specifically, the material of the pressurization mechanism 4 may be, for example, SUS316L, or may be Al, Ni, Cu, Mo, or the like.

The spacer 42 is preferably integrated with the wave washer 41 by being bonded thereto. This prevents displacement of the wave washer 41 during assembly of the structure 1, enabling uniform pressurization to be applied to the test specimen S. That is, the structure of the pressurization mechanism 4 can be configured simply and with high reproducibility, and is also excellent in mass productivity using commercially available components. According to such an aspect, pressure can be applied directly and reliably to the test specimen S housed inside, and the stability of the electrical connection and the reproducibility of the measurement can be improved.

### (Test Specimen S)

The test specimen S is an electrode stack configured by stacking an electrode S1, a separator S3, and an electrode S2. When the test specimen S is housed in the battery housing unit 2, an electrolyte is impregnated into the inside of the battery housing unit 2. When the test specimen S is housed and the structure 1 is provided as a finished product, the battery housing unit 2 is configured to house the test specimen S for a coin cell therein and to conduct an electrical signal output from the test specimen S to the outside.

Specifically, the electrode S1 in the test specimen S is in contact with the pressurization mechanism 4 (in particular, the spacer 42). In addition, the pressurization mechanism 4 (particularly, the wave washer 41) is in contact with the cap 21. As a result, the electrode S1 and the cap 21 can be electrically connected. Similarly, when the test specimen S is housed and the structure 1 is provided as a finished product, the electrode S2 in the test specimen S is in contact with the casing 22. As a result, the electrode S2 and the casing 22 can be electrically connected. That is, the battery housing unit 2 is electrically connected to the test specimen S via the pressurization mechanism 4. According to such an aspect, by allowing the pressurization mechanism 4 to also serve as an electrical connection means, the number of components can be reduced and functions can be integrated, and the structure 1 can also be handled like a commercially available coin cell.

### 2. Method for Manufacturing Structure 1

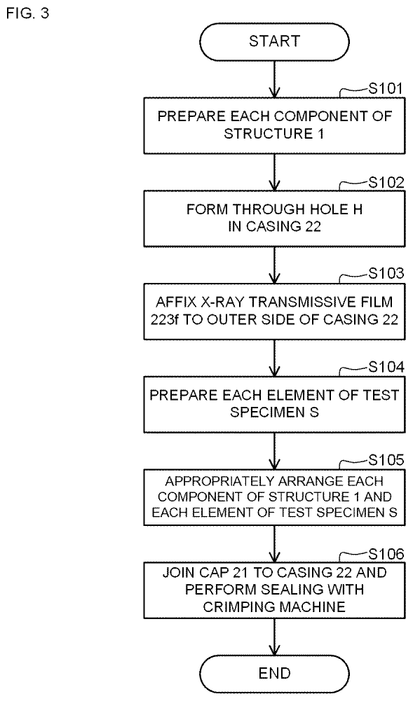

Next, a method for manufacturing the structure 1 according to one embodiment will be described with reference to FIG. 3. FIG. 3 is a flowchart showing an example of the method for manufacturing the structure 1 according to one embodiment. Note that the user may perform all of steps S101 to S106. Alternatively, the structure 1 may be shipped as a kit in a state where only the steps S101 to S103 have been performed, and a user who purchased the kit may perform the steps S104 to S106.

### (Start)

The components that constitute the structure 1, specifically, the cap 21, the casing 22, the gasket 3, the wave washer 41, and the spacer 42 are prepared (step S101). As these components, those distributed as components for commercially available coin cells can be used. Of course, instead of using the commercially available components, it is not precluded to newly produce components by press working, cutting, or the like.

Next, a through hole 223h is formed in substantially the center of the end surface 221 of the casing 22 (step S102). The diameter φ of the through hole 223h is preferably set within a range of 25% to 75% relative to the diameter Φ of the end surface 221. When laser processing is used, it is preferable to use a fiber laser or a UV laser to minimize a heat-affected zone. In the case of machining, end-milling finishing for deburring and electropolishing may be used in combination.

Next, an adhesive is applied in an annular shape to the inner periphery of the through hole 223h, and the X-ray transmissive film 223f is affixed to the outer side of the casing 22 (step S103). As a result, high adhesion and hermeticity can be obtained. Note that the film may be affixed to the inner side instead of the outer side.

Next, each component of the test specimen S is prepared (step S104). Specifically, the electrodes S1 and S2 are punched out to a predetermined diameter, and in the case of active-material-coated electrodes, an appropriate moisture content is preferably confirmed after vacuum drying. The separator S3 may be selected depending on the purpose, such as a porous PE/PP film or an inorganic solid electrolyte sheet. In addition, a certain amount of an electrolyte may be added dropwise or impregnated in advance as necessary.

Thereafter, each component of the structure 1 and each element of the test specimen S are arranged in predetermined positional relationships (step S105). Specifically, in the casing 22, the electrode S2, the separator S3, and the electrode S1 are stacked in this order, and the spacer 42 and the wave washer 41 are placed in this order on the stacked test specimen S. Furthermore, the gasket 3 is attached to the opening edge of the casing 22, and the cap 21 is placed thereon at a predetermined position. By slightly compressing the wave washer 41, a preload is applied to the entire electrode stack (that is, the electrode S1, the electrode S2, and the separator S3).

Finally, the cap 21 is joined to the casing 22. Using a crimping machine for commercially available coin cells, the wall on the casing 22 side is flared outward to wrap around the stepped edge of the cap 21, thereby completing the seal via the gasket 3 (step S106). At this time, the wave washer 41 undergoes a predetermined amount of elastic deformation, thereby applying a necessary surface pressure (for example, 1 to 5 MPa) to the test specimen S. After sealing, the test specimen S can be inspected, for example, by using the X-ray diffractometer 5 described in the next section (END).

In other words, a method for manufacturing the structure 1 for battery analysis is provided. The method includes a step of housing the test specimen S in the battery housing unit 2 by joining the cap 21 (an example of a first conductive member 2a) and the casing 22 (an example of a second conductive member 2b) using a crimping machine. According to such an aspect, a highly hermetic and highly precise structure 1 can be manufactured using processing methods similar to those of conventional coin cells, ensuring reproducibility and convenience in sample preparation.

### 3. X-Ray Diffractometer 5

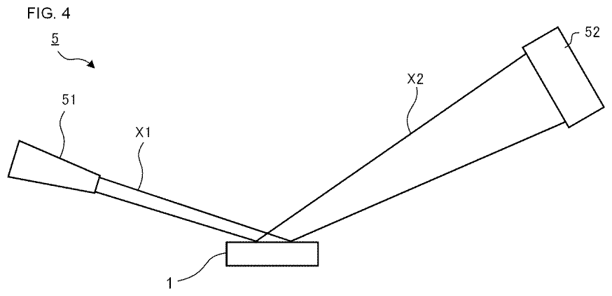

Next, an example of the X-ray diffractometer 5 to which the structure 1 is attached will be described. FIG. 4 is a side view showing an example of the X-ray diffractometer 5. The X-ray diffractometer 5 according to one example has a reflection-type configuration and includes an X-ray source 51, a sample stage (not shown), and a detector 52. The X-ray source 51 is configured to irradiate the structure 1 with incident X-rays X1.

The X-ray source 51 is configured to irradiate the structure 1 on the sample stage (not shown) with the incident X-rays X1. In this process, the X-rays irradiated from the X-ray source 51 to the structure 1 are converted into parallel X-rays, for example, by passing through an incident-side slit (not shown). Furthermore, the X-ray source 51 may be configured to emit the incident X-rays X1 composed of characteristic X-rays such as CuKα or MoKα.

The structure 1 is preferably placed on the sample stage (not shown). Specifically, the structure 1 is arranged so that the casing 22 faces upward (or forward), and the incident X-rays X1 are irradiated onto the X-ray window 223 of the structure 1. The incident X-rays X1 emitted from the X-ray source 51 pass through the X-ray window 223 of the structure 1 and are diffracted by the test specimen S inside the structure 1. The diffracted X-rays X2 are detected by the detector 52. The detector 52 may be a scintillation counter capable of zero-dimensional detection, or a semiconductor detector capable of one-dimensional or two-dimensional detection.

The X-ray diffractometer 5 includes at least an X-ray source 51, a sample stage on which the structure 1 can be placed, and the detector 52. However, optical elements or slit members (not shown) may be provided between the X-ray source 51 and the structure 1, and optical elements or slit members (not shown) may be provided between the structure 1 and the detector 52. The optical elements are composed of multilayer mirrors and crystals, and the slit members are formed of metal members such as Mo or W that do not transmit X-rays.

The configuration of the X-ray diffractometer 5 can be switched depending on the measurement method. The measurement method may be any generally known method, such as a focusing optical system or an optical system using a parallel beam. It is preferable to switch the system depending on the purpose of the measurement, for example, using a focusing optical system to increase X-ray diffraction intensity or using a parallel beam optical system to limit the irradiation area on the sample. Thus, in one embodiment, X-ray diffraction measurement can be performed on the test specimen S contained in the structure 1 by attaching the structure 1 to the X-ray diffractometer 5.

In other words, the X-ray diffractometer 5 includes a configuration configured to perform an X-ray diffraction measurement by attaching the structure 1 and irradiating the test specimen S housed in the battery housing unit 2 with X-rays through the X-ray window 223. According to such an aspect, by using the highly hermetic and highly precise structure 1 manufactured by processing methods similar to those used for commercially available coin cells, it is possible to provide the X-ray diffractometer 5 that can perform an X-ray diffraction measurement on a test specimen S under conditions close to those when manufactured as a commercially available coin cell.

### Others

The following aspects may be adopted for the structure 1 according to one embodiment or the X-ray diffractometer 5 to which the structure 1 is attached.

The structure 1 according to one embodiment has a configuration in which the X-ray window 223 is provided on the end surface 221 of the battery housing unit 2; however, a configuration may be adopted in which an X-ray window similar to the X-ray window 223 is provided on the end surface 211, or a configuration may be adopted in which X-ray windows (including the X-ray window 223) are provided on both the end surface 211 and the end surface 221. In such a case, a transmission-type apparatus may be adopted instead of the reflection-type X-ray diffractometer 5 described above. In addition, a plurality of X-ray windows (including the X-ray window 223) may be provided on one end surface (for example, the end surface 211 or 221).

The material for the X-ray transmissive film 223f is not limited to polymer materials (for example, PEI, PI, or the like), and a thin metal foil such as beryllium, aluminum, or titanium, an inorganic thin film such as silicon nitride or silica, or a composite film in which a metal thin film is vapor-deposited on a resin film may also be adopted.

The sealing of the X-ray window 223 is not limited to affixation using an adhesive, thin metal plate sealing by laser welding or resistance welding, ceramic window sealing by glass frit or inorganic brazing, mechanical clamping via an O-ring, or the like may be appropriately adopted. Even in such cases, attention should be paid to resistance to the electrolyte.

The battery housing unit 2 is not limited to a substantially cylindrical shape, and may have, for example, a shape obtained by removing a portion from a substantially cylindrical shape. For example, the shape may be a substantially regular polygonal prism. Even in such a case, manufacture using a crimping machine may be possible.

The pressurization mechanism 4 is not limited to the combination of the wave washer 41 and the spacer 42. For example, a disc spring, a coil spring, EPDM, a silicone rubber elastomer, a gas-filled diaphragm, a screw-type push plate, or the like may be adopted as the pressurization mechanism 4.

Furthermore, the present disclosure may be provided in each of the following aspects.
(1) A structure for battery analysis, comprising: a first conductive member; a second conductive member configured to be joined to the first conductive member; and an insulating member configured to insulate the first conductive member and the second conductive member from each other, the first conductive member and the second conductive member being joined to each other via the insulating member to form a hollow battery housing unit, the battery housing unit being configured to house a test specimen for a coin cell therein and to conduct an electrical signal output from the test specimen to the outside, on at least one of end surfaces of the battery housing unit, an X-ray window that allows X-rays to pass therethrough being provided.

According to such an aspect, it is possible to manufacture a highly hermetic and highly precise structure using processing methods similar to those used for commercially available coin cells, thereby allowing an X-ray diffraction measurement to be performed on a test specimen under conditions close to those when manufactured as a commercially available coin cell.
(2) The structure according to (1), wherein: the battery housing unit has a substantially cylindrical shape with a diameter of 30 mm or less and a height of 6 mm or less.

According to such an aspect, the structure can be provided in a size that encompasses the largest standard coin cell.
(3) The structure according to (1) or (2), wherein: the X-ray window includes: a through hole formed in at least one of the end surfaces of the battery housing unit; and an X-ray transmissive film configured to cover the through hole.

According to such an aspect, it is possible to achieve both X-ray transmissivity and hermeticity while realizing the X-ray window with a mechanically strong structure.
(4) The structure according to (3), wherein: the X-ray transmissive film includes a polymer material.

According to such an aspect, by using a film material having both X-ray transmissivity and electrolyte resistance, highly reliable X-ray measurements can be performed for a long period of time.
(5) The structure according to (3) or (4), wherein: the X-ray transmissive film is arranged by being bonded to at least one of the first conductive member or the second conductive member with an adhesive that is not dissolved by an electrolyte contained in the test specimen.

According to such an aspect, the fixation of the X-ray transmissive film by the adhesive becomes less susceptible to the influence of the electrolyte, and the hermeticity and durability of the structure can be improved.
(6) The structure according to any one of (1) to (5), wherein: the X-ray window has a substantially circular shape.

According to such an aspect, optically uniform X-ray irradiation with high symmetry becomes possible, and the reliability of measurement can be improved.
(7) The structure according to (6), wherein: the end surfaces each have a substantially circular shape, and a ratio of the diameter of the X-ray window to the diameter of each of the end surfaces is 25% to 75%.

According to such an aspect, by appropriately setting the size of the X-ray window, a balance between X-ray diffraction intensity and hermeticity can be ensured.
(8) The structure according to any one of (1) to (7), wherein: the X-ray window is provided only on one of the end surfaces.

According to such an aspect, simplification of the structure and clarification of the X-ray measurement position can be achieved, and alignment with the measurement device can also be easily ensured.
(9) The structure according to any one of (1) to (8), further comprising a pressurization mechanism arranged inside the battery housing unit and configured to apply pressure to the housed test specimen.

According to such an aspect, pressure can be applied directly and reliably to the test specimen housed inside, and the stability of the electrical connection and the reproducibility of the measurement can be improved.
(10) The structure according to (9), wherein: the pressurization mechanism includes an elastic member, and a plate-shaped member bonded to the elastic member.

According to such an aspect, the structure of the pressurization mechanism can be configured simply and with high reproducibility, and is also excellent in mass productivity using commercially available components.
(11) The structure according to (9) or (10), wherein: the pressurization mechanism has electrical conductivity, and the battery housing unit is electrically connected to the test specimen via the pressurization mechanism.

According to such an aspect, by allowing the pressurization mechanism to also serve as an electrical connection means, the number of components can be reduced and functions can be integrated.
(12) An X-ray diffractometer, comprising a configuration configured to perform an X-ray diffraction measurement by attaching the structure according to any one of (1) to (11) and irradiating a test specimen housed in the battery housing unit with X-rays through the X-ray window.

According to such an aspect, by using the highly hermetic and highly precise structure manufactured by processing methods similar to those used for commercially available coin cells, it is possible to provide the X-ray diffractometer that can perform an X-ray diffraction measurement on a test specimen under conditions close to those when manufactured as a commercially available coin cell.
(13) A method for manufacturing a structure for battery analysis, the structure being the structure according to any one of (1) to (11), the method comprising housing the test specimen in the battery housing unit by joining the first conductive member and the second conductive member using a crimping machine.

According to such an aspect, a highly hermetic and highly precise structure can be manufactured using processing methods similar to those of conventional coin cells, ensuring reproducibility and convenience in sample preparation.

Of course, the present disclosure is not limited thereto.

As mentioned above, various embodiments of the present disclosure have been described, but these are presented as examples and are not intended to limit the scope of the disclosure. The novel embodiment can be implemented in various other forms, and various omissions, replacements, and changes can be made without departing from the abstract of the disclosure. The embodiment and its modifications are included in the scope and abstract of the disclosure and are included in the scope of the disclosure described in the claims and the equivalent scope thereof.

### EXAMPLES

A structure of the Example (in which the diameter of the X-ray window was set at 50% relative to the diameter of the end surface, and PEI was adopted as the X-ray transmissive film) was prepared, while as the Comparative Example, a structure without an X-ray window, namely one having substantially the same configuration as a commercially available coin cell, was prepared. The latter will be referred to simply as the commercially available coin cell. The charge-discharge characteristics of these were measured. Specifically, measurement was performed for 10 cycles (that is, a total of 100 hours), where one cycle consisted of a set of one charge and one discharge at a rate (0.2C) such that one charge or discharge is completed in 5 hours.

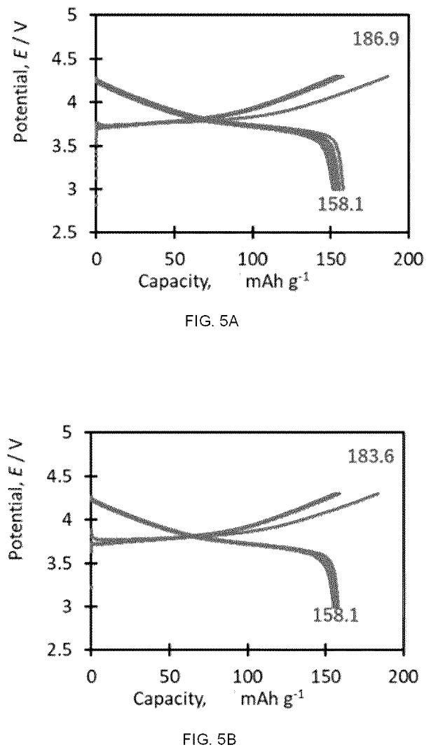

FIGS. 5A and 5B are graphs showing charge-discharge characteristics of the structure of the Example (FIG. 5A) and the commercially available coin cell according to the Comparative Example (FIG. 5B). The capacity of the commercially available coin cell was 157.4 mAhg⁻¹ at the initial value, whereas it was 155.3 mAhg⁻¹ after 10 cycles, which was 98.7% of the initial value. On the other hand, the capacity of the structure of the Example was 158.1 mAhg⁻¹ at the initial value, whereas it was 151.7 mAhg⁻¹ after 10 cycles, which was 96.0% of the initial value. Although the structure of the Example exhibits slightly inferior cycle characteristics compared to the commercially available coin cell of the Comparative Example, degradation remains small at 5% or less despite continuous measurement for 100 hours. In other words, the structure of the Example exhibits charge-discharge characteristics close to those of the commercially available coin cell, and it is expected that measurement values close to those obtained when actually manufacturing commercially available coin cells can be obtained when performing X-ray diffraction or the like.

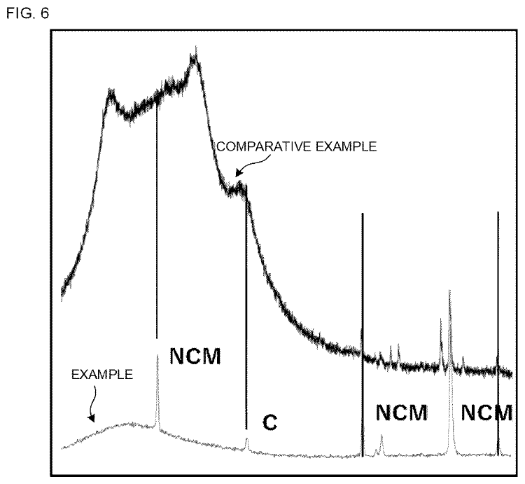

Furthermore, in addition to the structure according to the example, a structure using Kapton as the X-ray transmissive film was prepared as another comparative example. FIG. 6 is a graph showing the results of X-ray diffraction measurements performed on both the structure of the Example and the structure of the Comparative Example. In the structure of the Example, X-ray diffraction peaks derived from the internal test specimen were clearly observed. On the other hand, in the structure of the Comparative Example, no peaks could be detected. This confirmed that it is preferable to adopt PEI as the material for the X-ray transmissive film.

What is claimed is:

1. A structure for battery analysis, comprising:
a first conductive member;
a second conductive member configured to be joined to the first conductive member; and
an insulating member configured to insulate the first conductive member and the second conductive member from each other,
the first conductive member and the second conductive member being joined to each other via the insulating member to form a hollow battery housing unit,
the battery housing unit being configured to house a test specimen for a coin cell therein and to conduct an electrical signal output from the test specimen to the outside,
on at least one of end surfaces of the battery housing unit, an X-ray window that allows X-rays to pass therethrough being provided.

2. The structure according to claim 1, wherein:
the battery housing unit has a substantially cylindrical shape with a diameter of 30 mm or less and a height of 6 mm or less.

3. The structure according to claim 1, wherein:
the X-ray window includes:
a through hole formed in at least one of the end surfaces of the battery housing unit; and
an X-ray transmissive film configured to cover the through hole.

4. The structure according to claim 3, wherein:
the X-ray transmissive film includes a polymer material.

5. The structure according to claim 3, wherein:
the X-ray transmissive film is arranged by being bonded to at least one of the first conductive member or the second conductive member with an adhesive that is not dissolved by an electrolyte contained in the test specimen.

6. The structure according to claim 1, wherein:
the X-ray window has a substantially circular shape.

7. The structure according to claim 6, wherein:
the end surfaces each have a substantially circular shape, and
a ratio of the diameter of the X-ray window to the diameter of each of the end surfaces is 25% to 75%.

8. The structure according to claim 1, wherein:
the X-ray window is provided only on one of the end surfaces.

9. The structure according to claim 1, further comprising
a pressurization mechanism arranged inside the battery housing unit and configured to apply pressure to the housed test specimen.

10. The structure according to claim 9, wherein:
the pressurization mechanism includes an elastic member, and a plate-shaped member bonded to the elastic member.

11. The structure according to claim 9, wherein:
the pressurization mechanism has electrical conductivity, and
the battery housing unit is electrically connected to the test specimen via the pressurization mechanism.

12. An X-ray diffractometer, comprising
a configuration configured to perform an X-ray diffraction measurement by attaching the structure according to claim 1 and irradiating a test specimen housed in the battery housing unit with X-rays through the X-ray window.

13. A method for manufacturing a structure for battery analysis,
the structure being the structure according to claim 1,
the method comprising housing the test specimen in the battery housing unit by joining the first conductive member and the second conductive member using a crimping machine.
